(19) United States
(12) Patent Application Publication
(10) Pub. No.: US 2006/0168178 A1
(43) Pub. Date: Jul. 27, 2006

(54) Platform-independent system for remotely controlling home devices and method thereof

(75) Inventors: Tae In Hwang, Taejon (KR); Hyung Seop Hong, Gyeongsangbuk-Do (KR); Ho Jin Park, Taejon (KR); Kwang Roh Park, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/222,840

(22) Filed: Sep. 12, 2005

(30) Foreign Application Priority Data
Dec. 21, 2004 (KR) 2004-109659

(51) Int. Cl. G06F 15/173

(52) U.S. Cl. 709/223

(57) ABSTRACT

A platform-independent system and method for remotely controlling home devices and a computer-readable recording medium in which a program capable of executing the method is recorded are disclosed. The method includes installing a device control application to be used for the management of a home device when the home device is connected to the home network system, bring state information of the home device through the installed device control application, controlling a specified home device from an outside, receiving a report of an event occurring in the home device, and using a SOAP so that the above operations are performed irrespective of the middleware of a home gateway. Accordingly, the home devices connected to the home network through the home gateway can be controlled from the outside irrespective of the middleware supported by the home gateway.

### BACKGROUND OF THE INVENTION

1. Field of the Invention

The present invention relates generally to the control of home devices from an outside through a device management system in a home network environment, and more particularly to a platform-independent system for remotely controlling home devices and a method thereof that can control the home devices through a client terminal irrespective of a home gateway. The present invention also relates to a computer-readable recording medium in which a program capable of executing the method is recorded.

2. Background of the Related Art

Conventionally, “Method and Apparatus for Accessing a Home Network Using a Home Gateway and a Home Portal Server” proposed to access a home network from an outside of the home network only describes a method for mapping addresses for IP communications and a user authentication method for preventing an access of an unauthorized user from the outside of the home network when the user accesses the home network that uses a private network from the outside of the home network. That is, the above-described conventional method and apparatus just describe the control of home devices through a home gateway inside the home network that is performed by a management server located outside the home network, but fail to propose a method for directly controlling the home devices.

Meanwhile, “Proxy Apparatus for Controlling Home Network Devices and Method Thereof” conventionally proposed describes a method of controlling home devices by converting an HTTP (HyperText Transfer Protocol) command received from a web server into a UPnP (Universal Plug and Play) command. According to these conventional apparatus and method, however, an HTTP command generator and analyzer proposed by a service provider should be installed in a home gateway and a management server, respectively, in order to achieve communications between a home network and an outside of the home network using a service provider's independent remote function calling. In practice, this may cause problems in compatibility in the light of the actual state that respective home devices are made by different makers rather than by one maker.

### SUMMARY OF THE INVENTION

Accordingly, the present invention is directed to a platform-independent system and method for remotely controlling home devices and a computer-readable recording medium in which a program capable of executing the method is recorded that substantially obviate one or more problems due to limitations and disadvantages of the related art.

It is an object of the present invention to provide a platform-independent system and method for remotely controlling home devices and a computer-readable recording medium in which a program capable of executing the method is recorded, that can make a management server for managing home devices easily perform an integrated management of the home devices in performing communications with a home network even if environments (i.e., middleware, operating system, etc.) supported by home gateways installed at respective homes are different from one another when a new device is connected to the home network, using a SOAP (Simple Object Access Protocol) for accessing a remote procedure irrespective of a platform subject to communication.

It is another object of the present invention to provide a platform-independent system and method for remotely controlling home devices and a computer-readable recording medium in which a program capable of executing the method is recorded, that can provide a path through which a user outside a house can monitor and control the home devices connected to a home network.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided a platform-independent system for remotely controlling home devices, according to the present invention, which comprises a management server for generating a control command of the home device in response to a signal transmitted from a client terminal and transmitting a response message and event information from the home device corresponding to the control command to the client terminal, and a home gateway composed of a device control agent for receiving a message for connecting the home device, downloading a program required to control the corresponding home device using information about the home device and driving a device control application, a device control application unit having the device control application that is a program for receiving the command transferred from the device control agent and providing a message that can directly operate the home device according to a protocol that the home device uses, and a device sensor for sensing a connection of a new home device when the new home device is connected to the home gateway.

In another aspect of the present invention, there is provided a platform-independent method for remotely controlling home devices, which comprises a first step of a device sensor sensing a connection of a new home device, a second step of if the new home device is connected to a home gateway and a device connection message is generated from the new home device, transferring the device connection message to a device control agent, a third step of transmitting information about the corresponding home device to a management server and searching for a position of a device control application that is a program required to control the home device, a fourth step of downloading the device control application from the management server to the home gateway if the device control application is not installed, and a fifth step of installing the downloaded device control application and controlling the corresponding home device in association with a client terminal and the management server.

In still another aspect of the present invention, there is provided a recording medium in which a platform-independent method for remotely controlling home devices is recorded, that includes functions of sensing a connection of a new home device through a device sensor, if the new home device is connected to a home gateway and a device connection message is generated, transferring the device connection message to a device control agent, transmitting information about the corresponding home device to a management server and searching for a position of a device control application that is a program required to control the home device, downloading the device control application from the management server to the home gateway if the device control application is not installed, and installing the downloaded device control application and controlling the corresponding home device in association with a client terminal and the management server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the construction of home devices, a home gateway and a management server connected together according to the present invention;

FIG. 2 is a flowchart illustrating a process of installing a device control application according to an embodiment of the present invention;

FIG. 3 is a flowchart illustrating a process of searching and downloading a device control application according to an embodiment of the present invention; and

FIG. 4 is a flowchart illustrating a procedure of controlling a home device according to an embodiment of the present invention.

### DETAILED DESCRIPTION OF THE PREFERRED EMBODIMENT

A platform-independent system and method for remotely controlling home devices and a computer-readable recording medium in which a program capable of executing the method is recorded according to the preferred embodiment of the present invention will now be explained in detail with reference to the accompanying drawings.

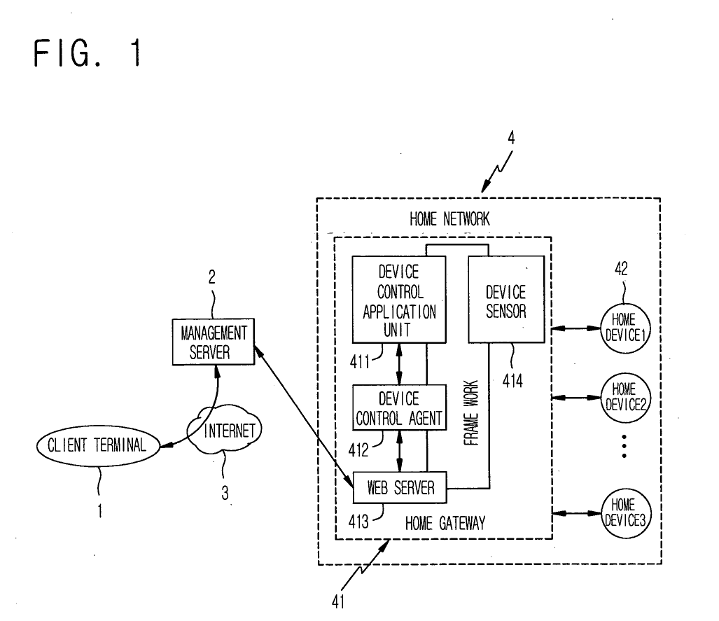

FIG. 1 is a view illustrating the construction of home devices, a home gateway and a management server connected together according to the present invention. As illustrated in FIG. 1, in order to perform the present invention, a client terminal 1, a management server 2, an Internet 3 and a home network 4 should basically be constructed.

The client terminal I may typically be a mobile terminal, a PDA, etc., that can be connected to the Internet to perform the control and monitoring of the home devices.

The management server 2 performs the general operation including-generation of a control command for controlling a home device in response to a signal transmitted from the client terminal 1 and transmission of an event and so on transferred from the home device through a network to the client terminal 1.

The home network 4 includes a home gateway 41 and home devices 42 connected to the home gateway 41. The home gateway is composed of a web server 413, a device control agent 412, a device control application unit 411 and a device sensor 414. The web server 413 receives the control signal for controlling the home device 42 transferred from the management server 2 and transfers the event from the home device 42 through the network. The device control agent 412 serves to receive and transfer the command sent from the management server 2 to the device control application unit 411. The device control application unit 411 has a device control application that is an application program that drives the home devices. The device control application unit receives the command transferred from the device control agent 412, and sends the home device a message that can directly operate the home device according to a protocol that the home device uses. The device sensor 414 senses a connection of a new home device when the new home device is connected to the home gateway. The home device 42 is a device that can be controlled through the network and includes a home appliance typically used at home.

Now, the functions of the management server 2 and the device control agent 412 will be explained in more detail. The management server 2 and the device control agent 412 are modularized by functions performed by the management server 2 and the device control agent 412.

The management server 2 performs the following functions.

First, the management server 2 has a function of reporting a device control connection. A new device broadcasts its device information through the home network 4 when it is connected to the home network 4, and the device sensor 414 provided in the home gateway 41 senses the connection of the new device. Then, the device sensor 414 informs the device control agent 412 of the device information, and the device control agent 412 informs the management server 2 of the device information.

Second, the management server 2 has a function of searching for the device control application. If the device control agent 412 recognizes the connection of the new device, it searches for the device control application required to control the new device. The device control agent 412 transmits the device information to the management server 2, and the management server 2 searches for a URL (Universal Resource Locator) of the device control application that matches the device information, and sends the URL to the device control agent 412 as a response. The device control agent 412 that has received the URL downloads, installs and drives the device control application.

Third, the management server 2 has a function of reporting events of the devices. That is, the management server 2 receives a report of information about service events produced from the devices 42 and performs a corresponding procedure according to the kind of events. For example, when a “door-open” event is produced in the home device, it is transferred from the device control agent 412 to the management server 2.

Meanwhile, the device control agent 412 performs the following functions.

First, the device control agent 412 has a function of inquiring a device list. That is, the device control agent 412 makes it possible to inquire the device list at home through a SOAP (Simple Object Access Protocol) message from the outside. The device control agent 412 makes the list of connected devices by calling a device list function installed in the home gateway 41, and sends the list to the client terminal 1 that has called the device list inquiry function as a response.

Second, the device control agent 412 has a device control function. The device control agent 412 serves to connect the message transmitted from the outside in the form of a SOAP message to the device control application unit 411 installed in the home gateway 41.

Third, the device control agent 412 has a function of joining the device event. The device control agent 412 serves to determine whether the management server 2 receives the report of the event of the device from the outside.

Fourth, the device control agent 412 has a device state inquiry function that is a function of inquiring the state information of the device from the outside. If a message for requesting the state value of the device is received from the outside, the device control agent 412 receives and sends the state variable value of the corresponding device in response to the message.

Here, the device control agent 412 includes a device control command processing means for analyzing and transferring the SOAP message received from the management server 2 to the home gateway 41 to the device control application.

In the construction as described above, the client terminal attempts to connect to the management server 2 through the Internet, and performs communications with the home network in association with the management server 2. A message transmitted/received between the management server 2 and the home gateway 41 is in the form of a SOAP message. The device control agent 412 analyzes the SOAP message using an XML parser. The home device 42 is connected to the home gateway 41 through the device sensor 414 and the device control application as an interface.

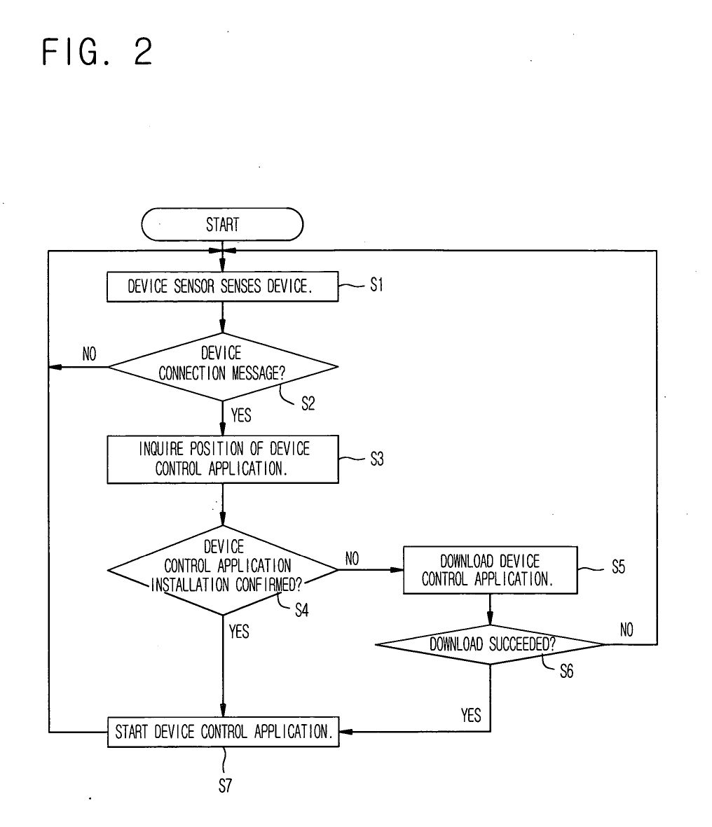

Hereinafter, the platform-independent system as constructed above, the method thereof and the computer-readable recording medium in which a program capable of executing the method is recorded will be explained in detail with reference to FIGS. 2 to 4.

FIG. 2 is a flowchart illustrating the process of installing the device control application according to an embodiment of the present invention. As illustrated in FIG. 2, the device sensor always senses the connection of a new device (step SI). If the new home device is connected to the home gateway and thus a device connection message is transferred from the device to the device control agent (step S2), the device control agent transmits information about the corresponding device to the management server and the management server searches for the position of a bundle required to control the corresponding device (step S3). After grasping the position of the bundle required for the control of the device, the device control agent confirms whether a device control application driver is installed (step S4). If the device control application driver is not installed, the device control agent downloads the device control application from the management server (step S5), and drives the device control application after the completion of the download (steps S6 to S7). If the above-described procedure is completed, the device control agent returns to the device sensing routine performed by the device sensor.

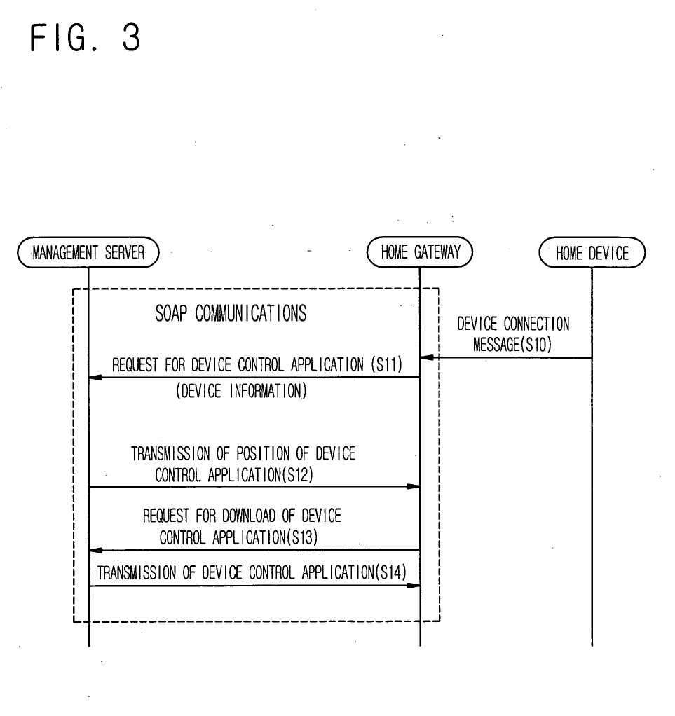

FIG. 3 is a flowchart illustrating the process of searching and downloading the device control application according to an embodiment of the present invention. As illustrated in FIG. 3, if a device connection message is transferred from the device to the home gateway (i.e., the device control agent) (step S10), the home gateway requests the device control application required to control the corresponding device to the management server (step S11). Accordingly, the management server searches for the position of the device control application, and sends a URL (Universal Resource Locator) of the device control application to the home gateway (step S12).

The home gateway requests the download of the device control application to the corresponding URL (step S13), and the corresponding device control application is downloaded to the home gateway in-response to the request for download (step S14).

At that time, a SOAP communication is performed between the home gateway and the management server.

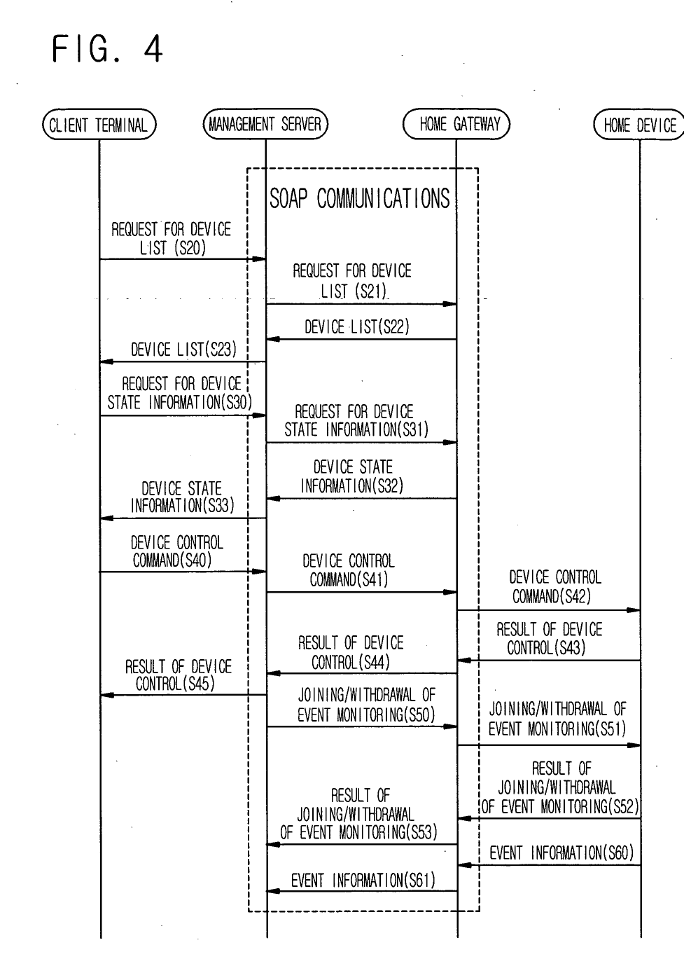

FIG. 4 is a flowchart illustrating the procedure of controlling the home device according to an embodiment of the present invention. As illustrated in FIG. 4, if a request for a device list is made by the client terminal (step S20), the management server sends a device list request message for requesting a device list to the home gateway (step S21), and the home gateway sends a list of devices being currently managed to the client terminal through the management server in response to the request message (steps S22 to S23).

If a device state information request is made from the client terminal (step S30), the management server sends a corresponding device state information request message to the home gateway (step S3 1), and the home gateway confirms and sends the device state to the client terminal through the management server in response to the message (steps S32 to S33).

If a device control request is made from the client terminal (step S40), the management server sends a device control command message to the home gateway (step S41), and the home gateway controls the corresponding device (step S42). Thereafter, the result of the device control is transmitted from the device to the home gateway (step S43), and the home gateway sends a control result message to the client terminal via the management server (steps S44 to S45).

Meanwhile, the management server can send an event joining/withdrawal message with respect to an event of the home device subject to management (steps S50 to S51). The home gateway that has received the event joining/withdrawal message sends an event monitoring joining/withdrawal response message to the management server as a result of the event joining/withdrawal (steps S52 to S53). The process -related to the event joining/withdrawal is performed by the request from the client terminal or the management server manager.

Additionally, the event information occurring in the home device is transmitted to the management server (step S60 to S61). Thereafter, the management server transfers an event message to the client terminal, and the client terminal performs the corresponding control operation.

As described above, according to the platform-independent system and method for remotely controlling home devices and the computer-readable recording medium in which a program capable of executing the method is recorded according to the present invention, the home devices can collectively be managed and controlled irrespective of the home gateway platform in the home network environment in which diverse home gateways coexist.

Additionally, the present invention provides a method for dynamically installing the device control application required to control a new device when the new device is installed, and thus can smoothly cope with the diverse home appliances added to the home network.

Accordingly, it is not necessary for the management server maker to consider which platform the home gateway uses, and the home gateway maker can make the home gateway without any consideration of the platform of the management server.

While the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. A platform-independent system for remotely controlling home devices, comprising:
a management server for generating a control command of the home device in response to a signal transmitted from a client terminal and transmitting a response message and event information from the home device corresponding to the control command to the client terminal; and
a home gateway composed of a device control agent for receiving a message for connecting the home device, downloading a program required to control the corresponding home device using information about the home device and driving a device control application, a device control application unit having the device control application that is a program for receiving the command transferred from the device control agent and providing a message that can directly operate the home device according to a protocol that the home device uses, and a device sensor for sensing a connection of a new home device when the new home device is connected to the home gateway.

2. The system as claimed in claim 1, wherein the management server comprises:
a device control connection report module for receiving a report of the home device information from the device sensor if the home device is connected to the home gateway;
a device control application searching module for searching and downloading the device control application required to control the newly installed home device; and
a home device event report module for receiving a report of a service event occurring in the home device.

3. The system as claimed in claim 1, wherein the device control agent comprises:
a device list inquiry module for inquiring a list of home devices from an outside through a SOAP (Simple Object Access Protocol) message;
a device control module for connecting the message transmitted from the outside in the form of the SOAP message to the device control application installed in the home gateway;
a device event joining module for determining whether the management server receives the report of the event of the device; and
a device state inquiry module for inquiring state information of the home device from the outside by receiving and sending a state variable value of the home device from the corresponding home device if a home device's state value request message is received from the outside.

4. The system as claimed in claim 1, wherein the device control agent further comprises a device control command processing means for analyzing and transferring the SOAP message received from the management server to the home gateway to the device control application.

5. A platform-independent method for remotely controlling home devices, comprising:
a first step of a device sensor sensing a connection of a new home device;
a second step of if the new home device is connected to a home gateway and a device connection message is generated from the new home device, transferring the device connection message to a device control agent;
a third step of transmitting information about the corresponding home device to a management server and searching for a position of a device control application that is a program required to control the home device;
a fourth step of downloading the device control application from the management server to the home gateway if the device control application is not installed; and
a fifth step of installing the downloaded device control application and controlling the corresponding home device in association with a client terminal and the management server.

6. The method as claimed in claim 5, further comprising the step of discriminating whether the device control application is installed before or after the third step.

7. The method as claimed in claim 5, wherein the fifth step comprises the substeps of:
the client terminal requesting a list of devices to the management server;
the management server transmitting a device list request message for requesting the list of devices to the home gateway;
the home gateway transmitting the list of devices being presently managed by the home gateway to the management server; and
the management server transmitting information about the corresponding list to the client terminal in response to the device list request.

8. The method as claimed in claim 5, wherein the fifth step comprises the substeps of:
the client terminal requesting device state information to the management server;
the management server transmitting a corresponding device state information request message to the home gateway;
the home gateway confirming the device state and transmitting a response message to the management server; and
the management server transmitting the response message to the client terminal.

9. The method as claimed in claim 5, wherein the fifth step comprises the substeps of:
the client terminal requesting a device control to the management server;
the management server transmitting a device control command message to the home gateway,
the home gateway controlling the corresponding home device;
the home device transmitting a result of the device control to the home gateway;
the home gateway transferring a control result message to the management server; and
the management server transmitting the control result message to the client terminal.

10. The method as claimed in claim 5, wherein the fifth step comprises the substeps of:
the management server transferring an event joining/withdrawal message to the home device via the home gateway with respect to an event of the home device subject to management; and
the home gateway receiving the event joining/withdrawal message from the home device, and transmitting an event monitoring joining/withdrawal response message that corresponds to a result of the event joining/withdrawal to the management server.
